(19) United States
(12) Patent Application Publication
(10) Pub. No.: US 2025/0000011 A1
(43) Pub. Date: Jan. 2, 2025

(54) METHOD AND DEVICE FOR ARRANGING SEED

(71) Applicant: Antje WOLFF, Timmendorfer Strand (DE)

(72) Inventor: Antje WOLFF, Timmendorfer Strand (DE)

(21) Appl. No.: 18/692,175

(22) PCT Filed: Sep. 14, 2022
(86) PCT No.: PCT/EP2022/075587

§ 371 Date: Mar. 14, 2024

(30) Foreign Application Priority Data
Sep. 15, 2021 (EP) 21196994.4
Dec. 6, 2021 (EP) 21212631.2

(51) Int. Cl. A01C 1/02

(52) U.S. Cl. CPC A01C 1/02

(57) ABSTRACT

A device for arranging seed includes a container with a container wall having an upper edge and a lower edge at a perpendicular distance from one another, a germination paper extending along the inside of the container wall, and a retaining device which cooperates with the germination paper in such a way that the seed is carried on the germination paper at or above an intermediate height above the lower edge and below the upper edge of the container wall in such a way that germs of the seed can grow upwards and roots of the seed can grow downwards.

The present invention relates to a method and a device for arranging seed. Such an arrangement, in which in particular a number of different seeds are positioned next to one another under comparable conditions, is of importance in connection with checking the germination capacity of the seed or seeds.

The provision of uniform growth conditions for individual plant seeds is advantageous for testing, in particular for comparative testing of the properties of seed. Uniform growth conditions are understood to mean, in particular, the same temperature, the same humidity, but also the same spatial conditions.

On the basis of such a comparative study, an assessment can be carried out effectively, for example of germination characteristics of the seed and/or of seedlings developing from the seed, taking into account, for example, time-related phenotypical characteristics.

EP 2 525 641 A1 deals with methods and devices for assessing the germination properties of plant seeds. It explains the phenotyping of seeds and the seedlings that develop from them using 3D X-ray computer tomography. In order to be able to carry out such procedures in a standardized and effective manner, the seeds must be germinated in a standardized germination medium. This is generally in the form of germination paper, which is normally placed horizontally in germination vessels in planar or pleated or folded form. In this case, however, the roots of the seedlings developing from the seed cannot develop downwards towards the centre of the earth in accordance with natural geotropism, but are forced to grow horizontally.

It is also known to arrange seed between two sheets of germination paper or a sheet that is folded lengthwise, and then roll these two sheets or halves of a paper together with the seeds arranged therein to form a roll, so that the seed cannot slip downwards even when the roll is positioned to be vertically orientated. The disadvantage of this is that a sometimes strong pressure is or can be exerted on the individual seeds, which hinders natural germination. It is also not possible to guarantee that the pressure or compression on different seeds is the same, so that overall uniform growth conditions cannot be guaranteed, making it difficult to objectively compare seeds to one another.

Seed must have certain minimum quality characteristics to ensure sufficient emergence and growth in the field, also in order to meet legal requirements for seed testing. The quality of the seed is a decisive factor in ensuring that the respective genotypic yield and quality characteristics can develop.

The aim of seed research and development is, among other things, to ensure the best possible early, high and uniform emergence, a high emergence speed, good growth performance and high stress tolerance. Among other things, this is intended to achieve the greatest possible uniformity of emergence and growth of the developing plants and the plants at harvest maturity, as well as a quantitatively and qualitatively high and uniform yield.

For these reasons, it is essential to compare the corresponding properties of different seeds from the same seed, as well as to compare different seed lots. The individual seeds are typically germinated in moistened filter paper of a defined quality, in so-called germination paper, under controlled humidity and temperature conditions over a certain period of time. After this period, the germinated seeds are counted manually or visually and, if necessary, the germination properties are assessed further, as described, for example, in EP 2 525 641 A1.

The present invention strives to enable such optimal and identical growth conditions for a large number of plant seeds to be examined in as simple a manner as possible.

This objective is achieved by a method comprising the features of claim 1 and a device comprising the features of claim 9.

It should be noted that the steps of the method according to the invention can be carried out in any order. For example, the seed paper can first be aligned vertically or upright and then the seed can be arranged at the intermediate height of the seed paper. It is also possible, and also included in the method according to the invention, to arrange the seed on the intermediate level while the seed paper is still aligned horizontally or in a lying orientation, for example, and only then to align or set up the seed paper vertically, whereby the seed is held or remains on the intermediate level. The term “perpendicular”, as used in the context of the embodiment of the present invention, is intended to include in particular a direction parallel to the direction of gravity, but also directions with an inclination or deviation of up to about 10 degrees or 5 degrees relative to the direction of gravity. The term “oblique” as used in the context of the embodiment of the present invention is intended to include, in particular, directions having an inclination of from about 10 degrees to about 45 degrees relative to the direction of gravity. Larger angles relative to the direction of gravity are also conceivable.

The term “germination paper” includes in particular a single, but also a plurality of sheets or sheets of germination paper. Some of the preferred embodiments of the invention can be realized in particular using a single sheet of pleated germination paper, in the vertically erected pleats or folds of which the seeds are held between the paper, while in other embodiments the simultaneous use of several sheets may also be appropriate.

According to the invention, it is ensured that the seedlings can grow as naturally as possible, as they follow natural geotropism, with the seedling or shoot growing upwards and the roots growing downwards (in particular towards the centre of the earth). In particular, the provision of vertically aligned, pleated or folded germination paper with slightly open folds makes it possible to hold the seed in such a way that it is not hindered in its natural development either by the pressure of the paper or by its horizontal alignment. This also reduces the space required compared to conventional solutions in which the germination paper is essentially aligned horizontally.

With to the invention, it can be ensured that a large number of seeds to be examined simultaneously can all be arranged at the same intermediate height of the vertically or obliquely aligned germination paper and held there securely. In particular, the seeds cannot slip or even fall from their vertical height or position. At the same time, they are constricted only minimally or as little as possible, so that all seeds, regardless of their size, are provided with the same conditions for an undisturbed, pressure-free germination process and stress-free seedling development. It is particularly advantageous that this non-slip, uniform and pressure-free germination of seeds on vertically or obliquely positioned germination paper can be achieved using just a single sheet of germination paper.

Advantageous embodiments of the invention are the subject matter of the dependent claims.

Advantageously, the seed is arranged at an intermediate height of the germination paper using a holding strip attached to the germination paper at or in the area of the intermediate height. Such a retaining strip is designed in particular as a narrow strip of fine non-woven paper (fleece paper). It expediently extends over the entire width of the germination paper. This germination or filter paper can be formed with or without folds, as explained below. The retaining strip preferably extends essentially parallel to the upper edge or lower edge of the germination paper, although an inclined arrangement relative to the upper edge or lower edge is also conceivable. The holding strip is designed in such a way that very fine seed is held there loosely as in a pocket to prevent it from slipping, in particular from slipping downwards, so that no pressure or mechanical stress is exerted on the seed that could impair germination. This embodiment requires only a single sheet of germination paper.

The holding strip is advantageously fixed to the germination paper in such a way that the holding strip consisting of fine fleece is only fixed to the germination paper at certain points, for example at regular intervals at connection points, so that the germination roots emerging from the seed can grow downwards through the spaces between these point fixations or connection points.

This fixation can advantageously be achieved by sewing on the fleece strip or by using a knurling technique, known as embossing, in which two different layers of paper, namely the germination paper and the fleece or nonwoven paper of the holding strip, are attached to each other by extremely strong embossing without adhesive. The choice of knurling (stitching) technique will typically depend on which form is expected to have the least impact on the growth behaviour of the seed. These two techniques make it easy to create the desired joints and gaps.

Conveniently, the retaining strip has an upper edge and a lower edge, the retaining strip being connected to the germination paper in the region of its lower edge at connection points spaced apart from one another, providing intermediate spaces open towards the lower edge of the germination paper. Other designs than connection points arranged parallel to the edge of the retaining strip, in particular as a seam or stitching line running parallel to the edge of the retaining strip, are also conceivable.

According to a further preferred embodiment, the placement of the seed on an intermediate level of the germination paper is accomplished using a retaining rail extending along the germination paper on the intermediate level. Such a retaining rail is expediently designed in such a way that the seed can be held securely on the intermediate level by means of the germination paper, with the seed only being in contact with the germination paper, and with the germs of the seed being able to grow upwards from the intermediate level and the roots of the seed being able to grow downwards from the intermediate level at the same time.

Such a retaining rail can be flexible, for example made of a flexible plastics material. This allows the retaining rail to be adapted to different bending states or orientations of the seed paper. For example, the seed paper can be rolled up to provide a cylindrical shape, in which case the retaining rail can take on a corresponding ring shape. The retaining rail can also be rolled up into a spiral shape, whereby it can be used to arrange seeds on a correspondingly spirally rolled up germination paper.

According to a particularly preferred embodiment of the invention, the germination or seed paper has a plurality of pleats or folds which extend parallel to one another from the upper edge to the lower edge of the germination paper. When the germination paper is positioned or oriented vertically, these folds extend vertically; when the germination paper is positioned at an angle, they extend at an angle.

By means of such folds, a sheet of germination paper can easily be used to provide a large number of individual areas for the germination of the respective seeds. The above-mentioned holding strip, preferably made of non-woven paper, preferably adapts to this folded structure. For example, a holding strip can be applied to a still planar germination paper and fixed to it, after which the germination paper is folded together with the holding strip attached to it to provide the plurality of folds. Such a combination of germination paper and retaining strip can also be used together with a retaining rail as described above.

According to a particularly preferred embodiment, the retaining rail is meander-shaped with a plurality of loops and connecting areas formed between the respective loops. Conveniently, the number of loops corresponds to the number of folds of the germination paper so that a loop can engage in each fold of the germination paper.

The connecting areas and the loops serve to fix the folds of the germination paper from the outside in a certain position, whereby the size, i.e. the width and depth, or in other words the opening angle of the individual folds can be set at or in the area of the intermediate height, depending on the dimensions of the connecting areas and the loops and/or their orientation relative to each other. In the area of this retaining rail, i.e. essentially at the intermediate height, the folds, which are themselves slightly open, are preferably gently pressed together by the loops of the retaining rail (retaining ring). This effectively creates a deposit point for the seed above this relative narrowing of the fold, on which it is held without being pressed and without touching the retaining rail. At the same time, the root of the seed has the opportunity to grow downwards through the narrowed or tapered area of the germination paper, while the germ or seedling can develop freely upwards in the open fold. The retaining rail thus provides a waist of the folds in the area of the intermediate height, on which the seed can be arranged in a non-slip manner, whereby above and below the intermediate height the fold can assume its original dimensions, i.e. width and depth.

The embodiments described above serve in particular to fix seed to a single sheet of germination paper. It is also advantageously possible to form retaining rails which are shaped in such a way that they fix, for example, two vertically or obliquely oriented sheets of germination paper arranged parallel to one another at an intermediate height, providing a narrow gap, so that seeds can be positioned on this gap between the two sheets without touching the retaining rails and without falling through them. This in turn allows roots developing from the seed to grow downwards through the gap without hindrance and the shoots to grow upwards from the seed. Such a retaining rail can be designed in particular as a frame-shaped, especially rectangular or curved profile, the length of which corresponds to the corresponding horizontal extension of the sheets of seed paper used and the width of which corresponds to the cumulative thickness of two sheets of seed paper plus the desired slit width. Such a profile can easily be slid onto two sheets of germination paper or, in other words, two sheets of germination paper can be slid into such a profile.

The device according to the invention comprises a container with a container wall which has an upper edge and a lower edge at a perpendicular distance H from one another, a germination paper extending in a region along the inside of the container wall. A carrying device is further provided which cooperates with the germination paper in such a way that the seed is carried on the germination paper at or above an intermediate level above the lower edge and below the upper edge of the container wall in such a way that germs of the seed can grow upwards from the intermediate level and roots of the seed can grow downwards from the intermediate level. “Carried on the germination paper” means in particular that the seed is exclusively in contact with the germination paper, i.e. that the holding device acts on the germination paper and the seed is held or fixed on the vertically aligned germination paper due to this effect. This is particularly the case with the aforementioned retaining rail. However, it is also possible, for example in the case of the holding strip also mentioned, that the seed is in contact with the holding device.

Expediently, the container is provided with a cylindrical, conical or polygonal shape. A germination paper can be adapted to such a container in a particularly simple way by bending it accordingly. Cylindrical or conical containers, in which seed is arranged in a circle along the circumference at the intermediate height, are particularly suitable for 3D X-ray analysis of the seeds Containers with a polygonal cross-section can also be used, whereby containers with a quadrangular, in particular square or rectangular cross-section should be mentioned in particular. If an inclined or oblique orientation of a germination paper is desired, containers with a correspondingly inclined container wall are particularly suitable, whereby cylindrical containers can also be used in this case. Both cylindrical and conical containers are suitable for the desired vertical orientation of a germination paper.

According to a preferred embodiment, the germination paper has a plurality of perpendicularly or obliquely extending folds. As already explained, “perpendicular” means in particular a direction parallel to the direction of gravity, but also directions with an inclination of up to about 10 degrees or 5 degrees relative to the direction of gravity. In particular, as mentioned, “oblique” is understood to mean inclinations of up to about 45 degrees relative to the direction of gravity.

As already mentioned, a retaining strip extending at the selected intermediate height or a retaining rail are preferably provided as a supporting device, whereby the retaining strip and retaining rail can be provided alone or in combination.

Conveniently, the retaining rail is flexible and/or meander-shaped with a plurality of loops and connecting areas provided between the respective loops.

According to a particularly preferred embodiment, the number of loops of the retaining rail corresponds to the number of folds or pleats. The width of the connecting areas corresponds to the desired distance between the folds and the clear distance between the meander loops corresponds to the desired degree of fold narrowing.

The invention will now be explained further with reference to the enclosed drawings, in which

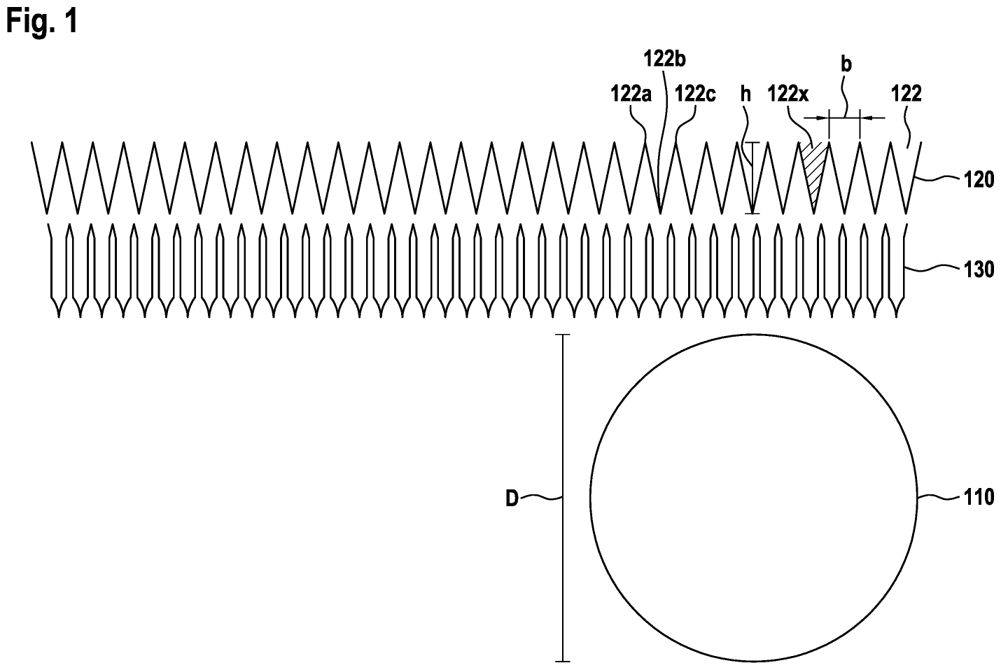

FIG. 1 shows the essential components of a first preferred embodiment of the device according to the invention before they are assembled,

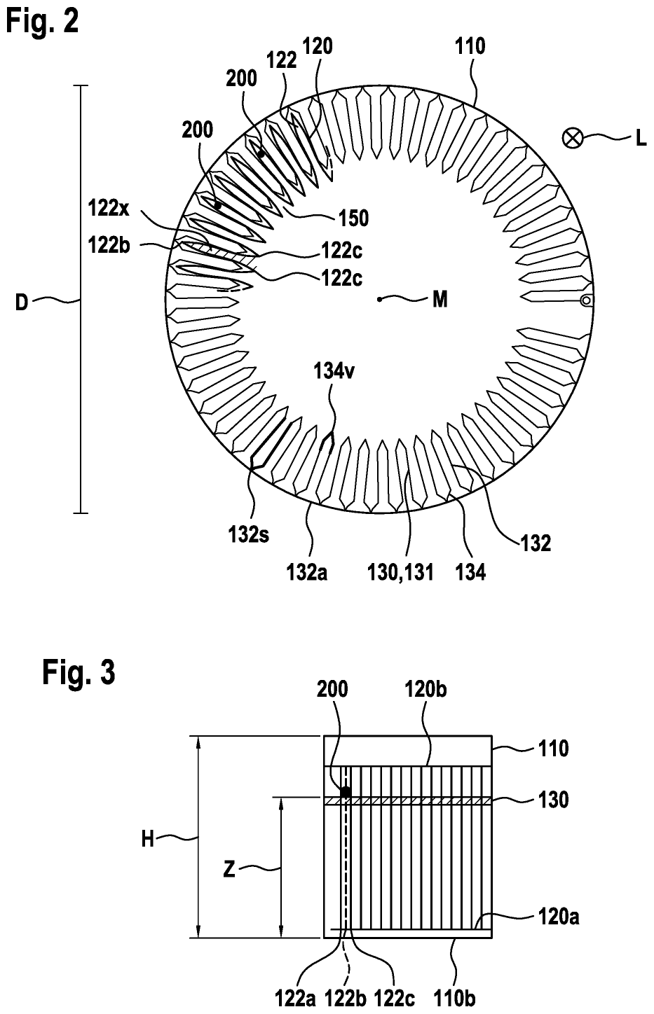

FIG. 2 is a schematic top view of the first preferred embodiment of the device according to the invention in an assembled state,

FIG. 3 is a schematic side view of the first preferred embodiment of the device according to the invention,

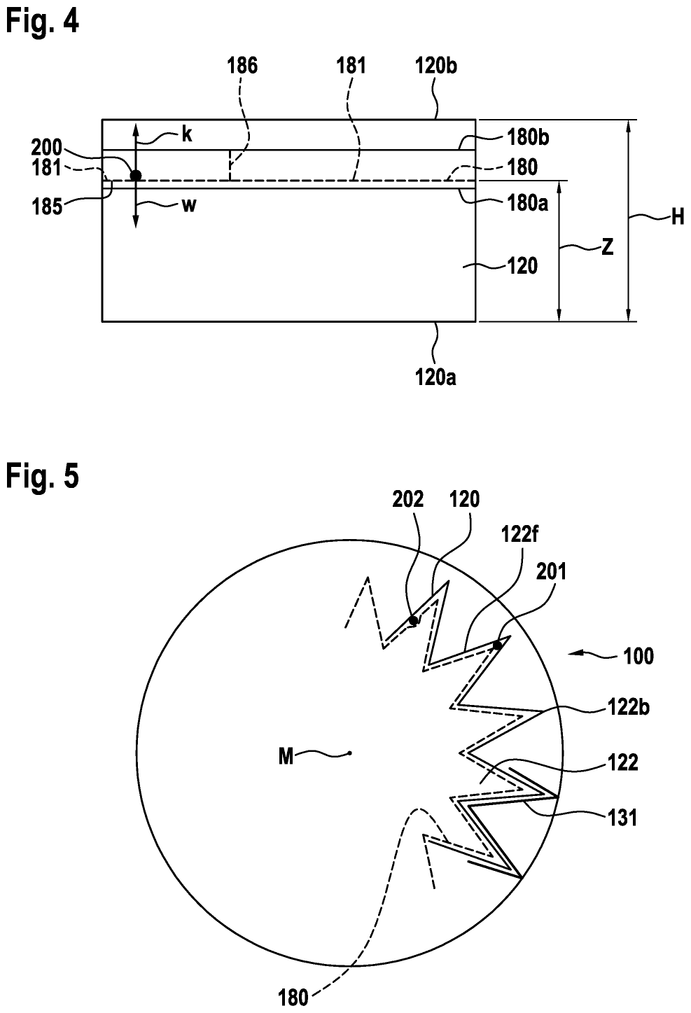

FIG. 4 is a schematic side view of a second preferred embodiment of the device according to the invention, and

FIG. 5 is a partial schematic top view of the second preferred embodiment of the device according to the invention.

A first preferred embodiment of the device according to the invention is explained with reference to FIGS. 1 to 3 and is referred to as a whole by reference numeral 100 (see in particular FIGS. 2 and 3). This device 100 comprises a cylindrical or conical transparent cup 110 with a diameter D and a height H (see FIG. 3), a germination paper 120 formed with a plurality of folds 122, which defines a lower edge 120a and an upper edge 120b, and a retaining rail 130 formed with a plurality of loops 132 and connecting regions 134 provided between the loops. The retaining rail 130 has a generally meandering shape. The retaining rail is flexible or elastic, so that it can be bent, for example, to provide a retaining ring 131 as shown in FIG. 2. Due to its elasticity, the retaining rail 130 can also be used for clamping folds and thus for its own fixation to the seed paper, as will be explained further below. The aforementioned components are shown in FIG. 1, separated and before they are assembled to form a device according to the invention.

As shown in particular in FIG. 1, the germination paper 120 comprises a plurality of folds 122 of a width b and a height h, which are each defined by three adjacent hinges 122a, 122b and 122c. The area of a respective fold 122 is shown hatched for illustration purposes in FIGS. 1 and 2 and labeled 122x. In the preferred embodiment shown, the hinges are formed as creases. The creases 122a and 122c represent the apexes, and crease 122b the trough of crease 122. The other folds are formed or dimensioned accordingly.

As can be seen in particular from FIGS. 2 and 3, these folds 122 or the corresponding creases 122a, 122b and 122c extend in a perpendicular direction L, i.e. following the geotropism parallel to the gravitational force or towards the centre of the earth, after the germination paper 120 has been arranged in the container 110 and when the container is normally used. It should be pointed out once again that an oblique orientation of the creases is also conceivable, but this is not shown in detail in the figures. When a cylindrical cup is used, the creases typically extend essentially perpendicularly; when a conical cup is used, they are perpendicular or slightly oblique to the perpendicular direction.

FIG. 2 shows how the retaining rail bent into retaining ring 131 interacts with the germination paper 120 formed with the plurality of folds 122. In FIG. 2, the germination paper 120 is curved into a cylindrical shape and arranged in the cylindrical container 110. To simplify the illustration, the germination paper 120 formed with folds 122 is not shown around the entire circumference of the container or the retaining ring.

It is also possible to use the germination paper 120 and the retaining rail in a linear manner, i.e. not curved into a circular or cylindrical shape, in accordance with the invention. These components can, for example, be placed in a correspondingly designed, elongated container to provide a device according to the invention without curvature, but this is not shown in detail here.

The retaining ring 131 is meander-shaped and has a plurality of loops 132, which are essentially U-shaped and whose clear distance within the loop determines the narrowing of the respective folds 122 at the intermediate height. To illustrate this, one such loop is drawn in bold in FIG. 2 and is designated 132s. Connecting regions 134 are formed between each of the loops 132. For illustration purposes, such a connecting region is also drawn in bold in FIG. 2 and designated 134v. The dimensioning of the connecting regions defines the distance between adjacent folds 122 at the level of the intermediate region. Overall, the retaining ring 131 can be attached or fixed to the seed paper in a non-slip manner due to its elasticity and the interaction with the germination paper shown.

In FIG. 2 it can be seen in particular that the folds 122 open towards the centre M of the container, whereby, as mentioned, they are narrowed or waisted due to the interaction with the retaining ring 131 at the intermediate height Z compared to the areas above and below. Seed can be deposited on this narrowing, possibly with simultaneous slight clamping with the narrowed fold, whereby it is ensured that it cannot slip downwards or fall down due to this narrowing. At the same time, the seed does not contact the retaining ring, but only the germination paper. For illustration purposes, two seeds are shown in FIG. 2 in a respective fold and designated 200.

It should be noted that it is expedient to attach the retaining rail to the folded germination paper while the germination paper 120 and retaining rail 130 are not yet rolled up. After attaching the retaining rail 130 to the germination paper 120, the composite thus provided can then be bent in a simple manner into a cylindrical or conical shape and then inserted into the container 110 in such a way that the retaining rail 130, which is now bent into the retaining ring 131, rests against the inner wall 110a of the container with the apexes 132a of the respective loops 132 (see FIG. 3). At the same time, the bottom edge 120a of the germination paper rests on the bottom 110b of the container 110, as shown in FIG. 3. The retaining ring 131 here runs along the inner wall 110a at the intermediate height Z of the container, as can be seen in particular in FIG. 3.

In this way, as shown in particular in FIG. 2, a plurality of germination areas 150 corresponding to the plurality of folds is provided, which are defined by the side walls of a respective fold 122 and a loop of the retaining ring. A plant seed of appropriate size can be securely deposited in each of these areas 150, whereby undesired falling through or slipping of the seed can be effectively avoided due to the downward narrowing of the fold 122 caused by the dimensioning of the loop.

In this way, substantially identical growing conditions for a plurality of seeds can be easily provided in the respective folds 122 or areas 150.

Here, in particular, each fold 122 is narrowed by the loops 132 or teeth of the retaining rail 130 or the retaining ring 131 at the intermediate height Z to such an extent that the corresponding seed placed on or slightly above the intermediate height Z cannot slip downwards, but the fold 122 is sufficiently open, in particular above and below the intermediate height, that the seed can germinate undisturbed and the germ (seedling) can develop undisturbed, but above all that the root can develop downwards unhindered. The width b of the folds can therefore, in other words, be varied at the intermediate height Z by a suitable choice of the retaining rail 130 or the retaining ring 131.

The strength of the fold compression and thus the design of the retaining rail 130 or the retaining ring 131 depends on the size of the seed. The embodiment shown above using a retaining rail proves to be very effective and reliable over a relatively large range of seed sizes or seed diameters. In the case of very small seeds, the narrowing of the folds by the retaining rail 130 or the retaining ring 131 shown would have to be very pronounced in order to reliably prevent downward slippage. Under certain circumstances, however, this can create too much pressure for small and correspondingly delicate plant seeds or seedlings, as a result of which not all seeds would find the same germination conditions.

To solve this problem, the present invention presents a second embodiment in which it is possible to fix even very small seeds without strong crimping. This embodiment is shown in FIGS. 4 and 5.

According to this embodiment, a narrow strip 180 of a fine non-woven paper or non-woven fabric is applied to the germination paper 120 at the intermediate height Z at which the seed is to be arranged on the germination paper. This strip expediently extends over the entire width of the germination paper 120 parallel to its upper edge 120b. The strip 180 has a lower edge 180a and an upper edge 180b. The strip 180 is fixed to the germination paper 120 at its lower edge 180a by means of spaced-apart connection points 181. In this embodiment, the connection points are arranged or spaced apart from one another essentially in a horizontal direction (when the germination paper 120 is aligned vertically), i.e. perpendicular to the direction of gravity. This fixation can be achieved, for example, by sewing the strip 180 onto the germination paper. However, knurling methods (so-called embossing) can also be used, in which two layers of paper, in this case the germination paper 120 and the non-woven paper of the strip 180, are joined together by strong embossing without adhesive. It should be noted that such seams and knurling can be formed in a particularly simple manner with gaps 185 between the connection points, through which roots developing from the seed can grow downwards, i.e. in the direction of gravity. At its upper edge 180b, the strip can either not be fixed to the germination paper at all or only at certain points, for example vertically above the connection points 181 of the lower edge.

It should also be noted that such connection points, in particular seams or knurls, do not necessarily have to be arranged or run in a horizontal direction.

Seed to be tested or examined can be inserted between the holding strip fixed to the germination paper in this way and the germination paper and held in a non-slip position. Roots developing from the seed can grow downwards through the gaps formed between the joints without interference or compression, and germs (seedlings) can grow upwards accordingly.

In particular, this embodiment can be used for very small seeds 200, whereby the roots can develop downwards (illustrated by arrow w in FIG. 4) through the spaces between the connection points 181. At the same time, germ (seedlings) emerging from the seed 200 can grow upwards in an unhindered manner (illustrated by arrow k in FIG. 4) out of the strip or the pockets 185 provided by it. Also, according to this embodiment, a plurality of areas is thus created which provide identical growth conditions for different plant seeds.

Above the connection points 181, a further fixing of the strip 180 to the germination paper can be provided, for example in the form of vertically extending seams 186, as indicated in FIG. 4. These can, for example, contribute to a stronger separation of neighbouring germination areas.

In this embodiment, the germination paper 120 may be in smooth or unfolded (see FIG. 4), or folded form. The latter will now be explained further, in particular with reference to FIG. 5:

Here, the strip 180 can first be applied to an unfolded or flat germination paper and fixed to it in the manner shown. The germination paper and strip can then be folded together to provide a plurality of folds. As mentioned, this composite of seed paper and non-woven paper can be used in linear form, i.e. without bending, in accordance with the invention. However, it is advantageously possible to form the composite of germination paper and non-woven paper (fleece paper) into a cylindrical shape and then position it in a corresponding cylindrical or conical container.

In FIG. 5, it can be seen that the retaining strip 180 (shown here as a dashed line) is attached with respect to the germination paper 120 on the side arranged towards the centre (centre point M) of the container 110. The germination paper and retaining strip are not shown over the entire circumference of the container. Since the germination paper 120 and retaining strip 180 are creased together to provide the plurality of folds 122, the contact pressure between the germination paper 120 and retaining strip 180 is typically somewhat lower in the area of the troughs or creases 122b than along the flanks, here designated 122f. In the case of particularly tender or small seeds, it is advantageous to arrange them in the area of the troughs between the germination paper and the holding strip. To illustrate this position, a correspondingly arranged seed is designated 201. However, it is also possible to position seeds on the flanks between the germination paper and the holding strip. A correspondingly arranged seed is shown for illustrative purposes and designated 202.

The embodiment according to FIG. 5 can be used together with a retaining ring 131, which is only shown schematically here, whereby a particularly secure fixing of seeds at the intermediate height on a vertically aligned germination paper can be achieved.

It should be noted that the strip 180 may be of particular fineness in order to be below the resolution of an X-ray detection and thus not to hinder an automatic image evaluation. On the other hand, it may be expedient to use a stronger non-woven paper (fleece paper) with a greater moisture absorption capacity for the strip 180, whereby more moisture can be provided overall on the intermediate height or placement horizon of the seed. On the other hand, such a strip can also be used to generate an intentional, standardized mechanical stress on the seed in order to investigate the seed's germinating or sprouting force.

The invention can also be realized in other embodiments not shown in detail in the figures. For example, two vertically or obliquely aligned germination papers can be arranged parallel or concentrically at a certain distance from one another, whereby these then each define an upper edge and a lower edge. This relative position or distance to each other can be narrowed at an intermediate height, for example a few centimetres beneath the upper edge, at an intermediate height by corresponding frame-shaped profiles, e.g. corresponding rails or rings. This relative position or spacing can be narrowed at an intermediate height, for example a few centimetres beneath or the top edge, by corresponding frame-shaped profiles, e.g. corresponding rails or rings, whereby a waisted or tapered area is provided at this intermediate height by inserting two sheets of germination paper arranged parallel to each other into the frame-shaped profile, on which seed can be safely positioned which only touches the germination paper and avoids contact with the frame-shaped profile, whereby seedlings developing from the seed can grow upwards without interference and roots can grow downwards through the narrowed area, i.e. in the direction of gravity. In the case of two concentric germination papers, for example, an inner ring is provided inside the concentric inner germination paper and an outer ring outside the concentric outer germination paper. The distance between the two rings, together with the corresponding thicknesses of the sheets of germination paper inserted between the rings, defines the width of an area in which seeds can be arranged or deposited. The distance between the rings can also define the degree of paper compression below the seed placement height, i.e. the intermediate height, and can be selected in accordance with the size of the seed and/or the thickness of the developing seed root. Here too, in the case of very small seed, further fixing of the seed by means of a pocket made of a fine strip of thin non-woven material can prevent the seed from slipping through without impairing germination. In this design, the rings are suitably smooth, i.e. without a meander structure.

It is also conceivable to form the two vertically or obliquely aligned germination papers with folds. In this case, the rails or rings are conveniently formed in a meandering shape with a large plurality of loops, whereby the number of loops corresponds to the number of folds.

The parallel arrangement of the germination papers can be used advantageously in particular if only a visual assessment of the seed is intended, and no assessment of the seed with imaging methods, in particular using 3D computer tomography.

All embodiments are distinguished by the fact that the contact areas between the seed and the germination paper are maximized so that moisture provided in the germination paper can be transferred to the seed to ensure optimal growth of germs (seedlings) from the seed.

1. A device for arranging seed, comprising
a container (110) with a container wall having an upper edge and a lower edge at a perpendicular distance H from one another,
a germination paper (120) extending along the inside of the container wall, and
a retaining device (130; 180) which cooperates with the germination paper in such a way that the seed is carried on the germination paper at or above an intermediate height above the lower edge and below the upper edge of the container wall in such a way that germs of the seed can grow upwards and roots of the seed can grow downwards.

2. The device according to claim 1, in which the container (110) is cylindrical or conical or polygonal.

3. The device according to claim 1, wherein the germination paper (120) comprises a plurality of vertically or obliquely extending folds (122).

4. The device according to claim 1, wherein the retaining device comprises a holding strip (180) extending at the intermediate height, which has an upper edge and a lower edge, wherein the holding strip (180) is connected to the germination paper at mutually spaced-apart connection points in the region of the lower edge.

5. The device according to claim 1, wherein the retaining device comprises a retaining rail (130) formed at the intermediate height.

6. The device according to claim 5, in which the retaining rail (130) is designed to be flexible and/or meandering with a plurality of loops (132) and connecting regions (134) provided between the respective loops.

7. The device according to claim 6, wherein the number of folds of the germination paper corresponds to the number of loops of the retaining rail.

8. A method of arranging seed on a germination paper, comprising the following steps:
aligning the germination paper (120) vertically or obliquely,
arranging of the seed (200) at an intermediate height (Z) of the germination paper (120) above a lower edge (120a) and below an upper edge (120b) of the germination paper,
wherein the arrangement is provided using a retaining strip (180) attached to the germination paper at the intermediate height, the retaining strip having an upper edge and a lower edge, the retaining strip being connected to the germination paper (120) in the region of its lower edge at mutually spaced-apart connection points (181) while providing intermediate spaces which are open towards the lower edge (120a) of the germination paper.

9. (canceled)

10. A method of arranging seed on a germination paper, comprising the following steps:
aligning the germination paper (120) vertically or obliquely,
arranging of the seed (200) at an intermediate height (Z) of the germination paper (120) above a lower edge (120a) and below an upper edge (120b) of the germination paper.

11. The method according to claim 10, wherein the arranging is accomplished using a retaining strip (180) attached to the seed paper at the intermediate height.

12. The method according to claim 11, wherein the retaining strip has an upper edge and a lower edge, wherein the retaining strip is connected to the germination paper (120) in the region of its lower edge at mutually spaced-apart connection points (181) while providing intermediate spaces open towards the lower edge (120a) of the germination paper.

13. The method according to claim 10, wherein the arranging is accomplished using a retaining rail (130) extending along the germination paper (120) at the intermediate height.

14. The method according to claim 13, in which the retaining rail (130) is designed to be flexible.

15. The method according to claim 13, wherein the retaining rail is meander-shaped.

16. The method according to claim 10, wherein the germination paper comprises a plurality of perpendicularly or obliquely extending folds (122).

17. The method according to claim 11, wherein the germination paper is bent into a cylindrical or conical shape together with the retaining strip and is arranged in a cylindrical or conical container (110).

18. The method according to claim 13, wherein the germination paper is bent into a cylindrical or conical shape together with the retaining rail and is arranged in a cylindrical or conical container (110).
